(19) United States
(12) Patent Application Publication
(10) Pub. No.: US 2022/0006955 A1
(43) Pub. Date: Jan. 6, 2022

(54) CONTROL DEVICE, NON-TRANSITORY STORAGE MEDIUM, AND CONTROL SYSTEM

(71) Applicant: TOYOTA JIDOSHA KABUSHIKI KAISHA, Toyota-shi (JP)

(72) Inventors: Satoshi KOMAMINE, Nagoya-shi (JP); Hideo HASEGAWA, Nagoya-shi (JP)

(73) Assignee: TOYOTA JIDOSHA KABUSHIKI KAISHA, Toyota-shi (JP)

(21) Appl. No.: 17/357,065

(22) Filed: Jun. 24, 2021

(30) Foreign Application Priority Data
Jul. 3, 2020 (JP) 2020-115830

(51) Int. Cl. H04N 5/232; H04N 7/18

(52) U.S. Cl. CPC H04N 5/23245; H04N 5/23219; H04N 5/23206; H04N 7/188; H04N 7/185

(57) ABSTRACT

A control device includes a controller configured to output, when a sign of starting a specific action by a user is detected, a signal for switching an operation mode of a camera from a first mode to a second mode different from the first mode. The camera is configured to operate in the first mode in which data on a captured image generated by imaging an indoor place is stored in the camera.

### CROSS-REFERENCE TO RELATED APPLICATION

This application claims priority to Japanese Patent Application No. 2020-115830 filed on Jul. 3, 2020, incorporated herein by reference in its entirety.

### BACKGROUND

### 1. Technical Field

The present disclosure relates to a control device, a non-transitory storage medium, and a control system.

### 2. Description of Related Art

There is known a device configured to acquire an image captured by a camera and determine whether to display the image in a first mode or a second mode based on markers detected from the image (for example, Japanese Unexamined Patent Application Publication No. 2014-130438 (JP 2014-130438 A)). In JP 2014-130438 A, the amount of information related to a target person in an image to be displayed in the second mode is set smaller than the amount of information related to a target person in an image to be displayed in the first mode.

### SUMMARY

There is a demand to protect privacy more securely.

The present disclosure is intended to protect privacy more securely.

A first aspect of the present disclosure relates to a control device. The control device includes a controller configured to output, when a sign of starting a specific action by a user is detected, a signal for switching an operation mode of a camera from a first mode to a second mode different from the first mode. The camera is configured to operate in the first mode in which data on a captured image generated by imaging an indoor place is stored in the camera.

In the first aspect, the controller may be configured to output a signal for switching the operation mode of the camera to the first mode when an end of the specific action is detected.

In the first aspect, the controller may be configured to detect the end of the specific action by detecting an action pattern indicating the end of the specific action from the captured image generated by the camera.

In the first aspect, when the operation mode of the camera is the second mode, masking may be performed for an image portion corresponding to the user in the captured image generated by the camera and data on the captured image subjected to the masking may be stored in the camera.

In the first aspect, the indoor place may be a room in a house. When the operation mode of the camera is the second mode, when determination is made that the user is a resident of the house, masking may be performed for an image portion corresponding to the user in the captured image generated by the camera based on determination that the user is a resident of the house and data on the captured image subjected to the masking may be stored in the camera.

In the first aspect, when the operation mode of the camera is the second mode, the masking may not be performed for an image portion corresponding to a person who is not the resident of the house in the captured image generated by the camera.

In the first aspect, when the operation mode of the camera is the second mode, the data on the captured image generated by the camera may not be stored in the camera.

In the first aspect, the controller may be configured to output, after the signal for switching the operation mode of the camera to the second mode is output, a signal for switching the operation mode of the camera to the first mode based on detecting an end of the specific action by detecting that no person is present in the indoor place by using a motion sensor.

In the first aspect, the controller may be configured to output, after the signal for switching the operation mode of the camera to the second mode is output, a signal for switching the operation mode of the camera to the first mode based on detecting an end of the specific action by detecting that the user exits from the indoor place from the captured image generated by the camera.

In the first aspect, the specific action of the user may be an action that the user takes off clothes.

In the first aspect, the specific action may be an action that the user changes clothes.

In the first aspect, the controller may be configured to detect the sign of starting the specific action by detecting an action pattern indicating the sign of starting the specific action from the captured image generated by the camera.

In the first aspect, the controller may be configured to determine the action pattern indicating the sign of starting the specific action based on a captured image previously generated by the camera.

In the first aspect, the specific action may be preset by the user.

A second aspect of the present disclosure relates to a non-transitory storage medium storing instructions that are executable by one or more processors in a computer and that cause the one or more processors to perform the following functions.

The functions include causing a camera to operate in a first mode in which data on a captured image generated by imaging an indoor place is stored in the camera, and outputting, when a sign of starting a specific action by a user is detected, a signal for switching an operation mode of the camera to a second mode different from the first mode.

A third aspect of the present disclosure relates to a control system. The control system includes a camera and a control device. The camera is configured to operate in a first mode in which data on a captured image generated by imaging an indoor place is stored in the camera. The control device is configured to output, when a sign of starting a specific action by a user is detected, a signal for switching an operation mode of the camera to a second mode different from the first mode.

In the third aspect, the camera may include a shutter configured to be openable and closable relative to a lens of the camera. The shutter may be configured to be open relative to the lens in the first mode. The shutter may be configured to be closed relative to the lens in the second mode.

In the third aspect, the camera may include an indicator. A controller of the control device may be configured to output a signal for keeping the indicator illuminated while the operation mode of the camera is the second mode.

In the third aspect, the camera may include a microphone configured to collect sounds in the indoor place. A controller of the control device may be configured to output, after the signal for switching the operation mode of the camera to the second mode is output, a signal for terminating the second mode and switching the operation mode of the camera to the first mode based on detecting a sound having a frequency higher than a frequency threshold by the microphone.

In the third aspect, the camera may include a microphone configured to collect sounds in the indoor place. A controller of the control device may be configured to output, after the signal for switching the operation mode of the camera to the second mode is output, a signal for terminating the second mode and switching the operation mode of the camera to the first mode based on detecting the microphone detects a sound having a sound pressure higher than a sound pressure threshold by the microphone.

According to the first aspect, the second aspect, and the third aspect of the present disclosure, privacy can be protected more securely.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the configuration of a control system according to one embodiment of the present disclosure;

FIG. 2 is a block diagram illustrating a detailed configuration of the control system illustrated in FIG. 1;

FIG. 3 is a sequence diagram illustrating an example of operations of the control system illustrated in FIG. 1; and

FIG. 4 is a block diagram illustrating a detailed configuration of a control system according to another embodiment of the present disclosure.

### DETAILED DESCRIPTION OF EMBODIMENTS

Embodiments of the present disclosure are described below with reference to the drawings. In the drawings, the same constituent elements are represented by the same reference symbols.

Configuration of Control System

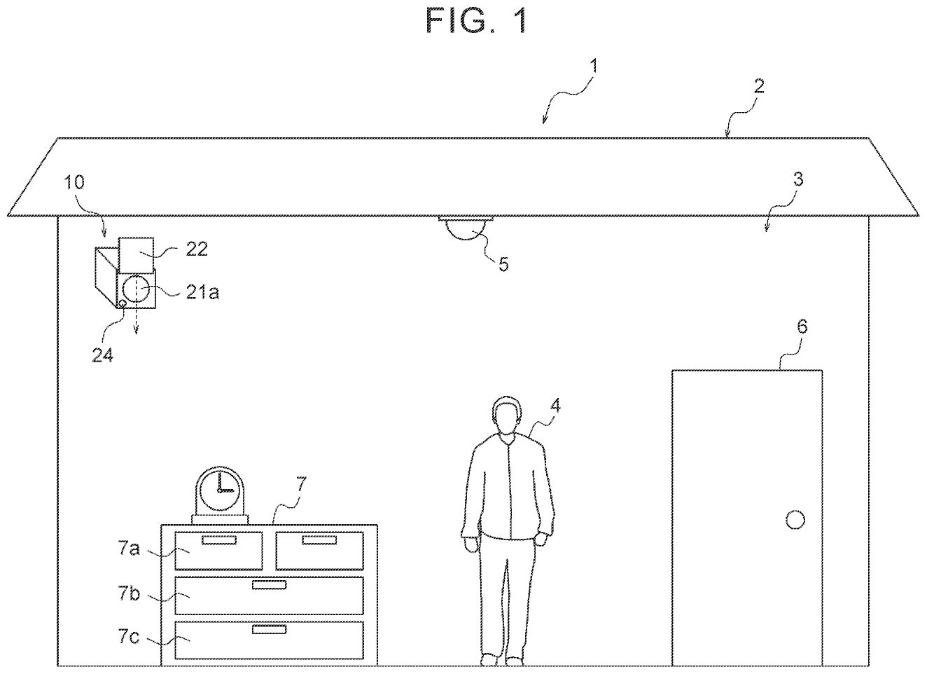

As illustrated in FIG. 1, a control system 1 according to one embodiment of the present disclosure includes a camera device 10. The control system 1 may further include a motion sensor 5. The camera device 10 is located at a position where the camera device 10 can image an indoor place. The indoor place to be imaged by the camera device 10 is hereinafter a room 3 in a house 2. As described later, the indoor place to be imaged by the camera device 10 is not limited to the room 3 in the house 2.

Examples of the camera device 10 include a surveillance camera, a security camera, and a hazard camera.

A user 4 may be present in the room 3. The user 4 may be a resident of the house 2. A door 6 may be provided at a gate of the room 3. The user 4 may exit from the room 3 by opening the door 6. A chest of drawers 7 may be arranged in the room 3. The chest of drawers 7 may include drawers 7a, 7b, and 7c. For example, the user 4 stores valuable items in the drawer 7a. Examples of the valuable items include a coin, a bank note, and a bill. For example, the user 4 stores bath towels and underclothes in the drawer 7b. For example, the user 4 may store clothes in the drawer 7c.

The motion sensor 5 is located at a position where the motion sensor 5 can detect the presence or absence of a person in the room 3. For example, the motion sensor 5 is located on the ceiling of the room 3. The motion sensor 5 includes an infrared sensor. For example, the motion sensor 5 detects the presence or absence of a person in the room 3 by detecting a thermal change in the room 3. The motion sensor 5 and the camera device 10 may communicate with each other. The motion sensor 5 may transmit, to the camera device 10, detection information indicating the presence or absence of a person in the room 3.

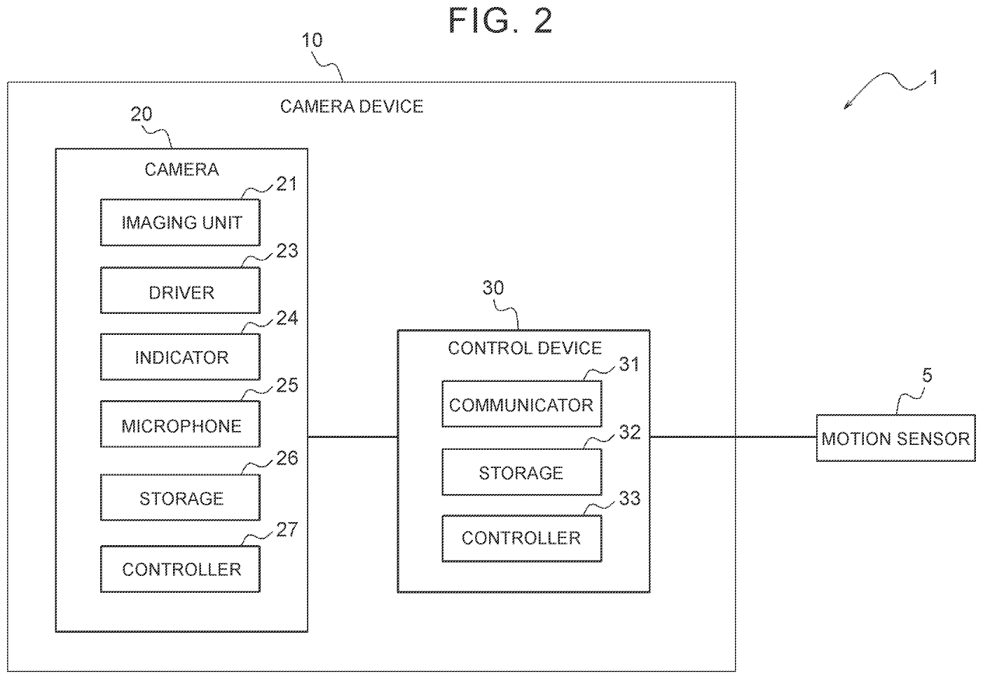

As illustrated in FIG. 2, the camera device 10 includes a camera 20 and a control device 30. For example, the camera 20 and the control device 30 are communicably connected together via a dedicated line.

The camera 20 can generate a captured image by imaging the room 3. The captured image may be a still image or a moving image. The camera 20 includes an imaging unit 21, a storage 26, and a controller 27. The storage 26 and the controller 27 may be included in the control device 30. As illustrated in FIG. 1 and FIG. 2, the camera 20 may further include a shutter 22, a driver 23, an indicator 24, and a microphone 25.

The imaging unit 21 can generate a captured image by imaging the room 3 as a subject. The imaging unit 21 outputs data on the generated captured image to the controller 27. The imaging unit 21 may execute imaging at an arbitrary frame rate based on control of the controller 27. If the camera device 10 is a surveillance camera or the like, the imaging unit 21 may execute imaging continuously.

The imaging unit 21 may include an imaging optical system and an imaging element. The imaging optical system may include optical elements such as a lens and a stop. The imaging optical system condenses light beams of a subject image incident from the outside of the camera device 10 on a light receiving surface of the imaging element. Examples of the imaging element include a charge coupled device (CCD) image sensor and a complementary metal-oxide semiconductor (CMOS) image sensor. The imaging element generates a captured image by capturing the subject image formed on the light receiving surface.

The imaging optical system of the imaging unit 21 includes a lens 21a illustrated in FIG. 1 as the optical element. The lens 21a is located on an outermost side of the camera device 10 among lenses in the imaging unit 21.

The shutter 22 is openable and closable relative to the lens 21a. The shutter 22 may be opened or closed relative to the lens 21a by being driven by the driver 23.

The shutter 22 may be opened or closed relative to the lens 21a by sliding relative to the lens 21a. The shutter 22 may be opened or closed relative to the lens 21a by turning relative to the lens 21a.

When the shutter 22 is open relative to the lens 21a, light beams of a subject image may enter the lens 21a from the outside of the camera device 10. That is, when the shutter 22 is open relative to the lens 21a, the imaging unit 21 can generate a captured image by imaging the room 3.

When the shutter 22 is closed relative to the lens 21a, the lens 21a may be covered with the shutter 22. When the lens 21a is covered with the shutter 22, light beams of a subject image cannot enter the lens 21a from the outside of the camera device 10. That is, when the shutter 22 is closed relative to the lens 21a, the imaging unit 21 cannot image the room 3.

The size of the shutter 22 may be larger than the size of the lens 21a. The shutter 22 may be made of an arbitrary material such as a resin or metal material. The shutter 22 may be located at a position where the user 4 can recognize the shutter 22. For example, the shutter 22 is located outside a casing of the camera device 10 as the position where the user 4 can recognize the shutter 22. The shutter 22 may be a member provided separately from the stop in the imaging unit 21. The stop in the imaging unit 21 may be used as the shutter 22 instead.

The driver 23 opens or closes the shutter 22 based on an electric signal output from the controller 27. The driver 23 may include an actuator. The actuator converts the electric signal output from the controller 27 into a force for opening or closing the shutter 22.

The indicator 24 is illuminable. The indicator 24 may include a light source such as a light emitting diode (LED). The indicator 24 may be located at a position where the user 4 can recognize the indicator 24. For example, the indicator 24 is located outside the casing of the camera device 10 as the position where the user 4 can recognize the indicator 24.

The microphone 25 can collect sounds in the room 3. The microphone 25 outputs data on the collected sounds to the controller 27. The microphone 25 may be an electrostatic microphone.

The storage 26 may include at least one semiconductor memory, at least one magnetic memory, at least one optical memory, or a combination of at least two types among those memories. Examples of the semiconductor memory include a random access memory (RAM) and a read only memory (ROM). Examples of the RAM include a static random access memory (SRAM) and a dynamic random access memory (DRAM). Examples of the ROM include an electrically erasable programmable read only memory (EEPROM). The storage 26 may function as a main storage, an auxiliary storage, or a cache memory. The storage 26 stores data for use in an operation of the camera 20, and data obtained through the operation of the camera 20.

The controller 27 may include at least one processor, at least one dedicated circuit, or a combination of the processor and the dedicated circuit. The processor is a general processor such as a central processing unit (CPU) or a graphics processing unit (GPU), or a dedicated processor for specific processes. Examples of the dedicated circuit include a field-programmable gate array (FPGA) and an application specific integrated circuit (ASIC). The controller 27 may execute processes related to the operation of the camera 20 while controlling individual parts of the camera 20.

Functions of the camera 20 may be implemented such that the processor corresponding to the controller 27 executes a processing program according to this embodiment. That is, the functions of the camera 20 may be implemented by software. The processing program may cause a computer to function as the camera 20 by causing the computer to execute the operation of the camera 20. That is, the computer may function as the camera 20 by executing the operation of the camera 20 based on the processing program.

In the present disclosure, the “program” can be recorded in a non-transitory computer readable recording medium. Examples of the non-transitory computer readable recording medium include a magnetic recording device, an optical disc, a magneto-optical recording medium, and a ROM. For example, the program is distributed by selling, transferring, or lending a portable recording medium such as a digital versatile disc (DVD) or a compact disc read only memory (CD-ROM) that records the program. The program may be stored in a storage of a server. The program stored in the storage of the server may be distributed by being transferred to another computer. The program may be provided as a program product.

In the present disclosure, for example, the “computer” may temporarily store, in a main storage, the program recorded in the portable recording medium or the program transferred from the server. The computer may be configured such that the processor reads the program stored in the main storage and executes processes based on the read program. The computer may directly read the program from the portable recording medium and execute the processes based on the program. Every time programs are transferred from the server to the computer, the computer may sequentially execute processes based on the received programs. The computer may execute processes by a service from a so-called application service provider (ASP) by which functions are implemented by sending execution instructions and receiving results without transferring programs from the server to the computer. The program may include information equivalent to the program and served for use in processes to be executed by an electronic computer. For example, data that is not a direct command to the computer but has a property to define a process to be executed by the computer corresponds to the “information equivalent to program”.

The functions of the camera 20 may partially or entirely be implemented by the dedicated circuit corresponding to the controller 27. That is, the functions of the camera 20 may partially or entirely be implemented by hardware.

The controller 27 controls the functions of the individual parts of the camera 20 based on signals output from the control device 30. For example, the controller 27 causes the camera 20 to operate in a first operation mode or a second operation mode described later based on a signal output from the control device 30. Details of the processes to be executed by the controller 27 are described later.

As illustrated in FIG. 2, the control device 30 includes a communicator 31, a storage 32, and a controller 33.

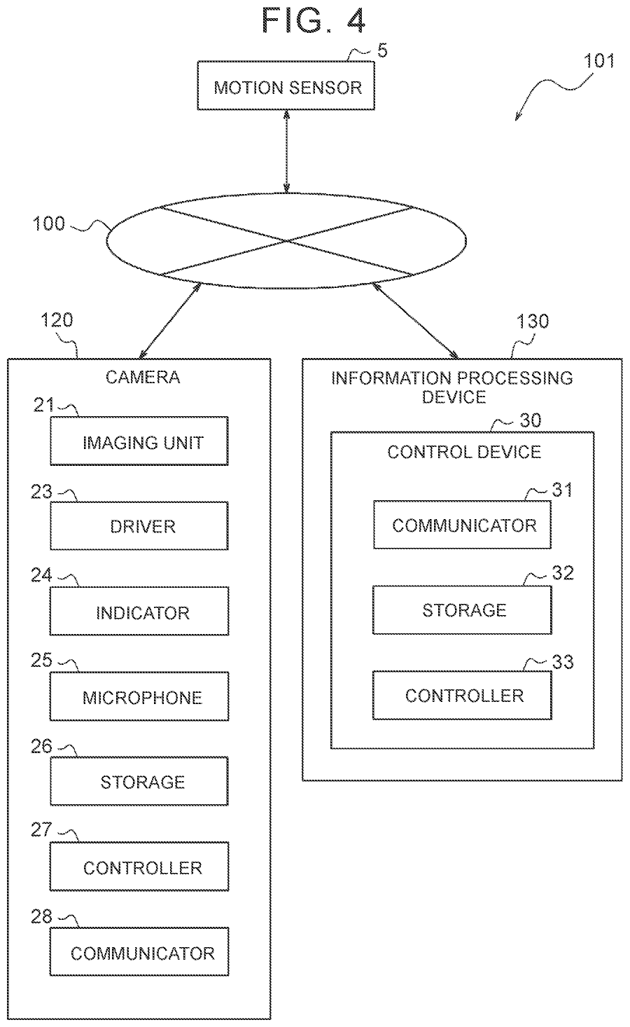

The communicator 31 may include at least one communication module communicable with the motion sensor 5. For example, the communication module conforms to standards such as a wired local area network (LAN) or a wireless LAN. The communicator 31 may communicate with the motion sensor 5 via the wired LAN or the wireless LAN by using the communication module. The communicator 31 may be connected to a network 100 described later as illustrated in FIG. 4 via the wired LAN or the wireless LAN by using the communication module.

Similarly to the storage 26, the storage 32 may include at least one semiconductor memory, at least one magnetic memory, at least one optical memory, or a combination of at least two types among those memories. The storage 32 stores data for use in an operation of the control device 30, and data obtained through the operation of the control device 30. The storage 32 may store data on a facial image of at least one resident of the house 2.

Similarly to the controller 27, the controller 33 may include at least one processor, at least one dedicated circuit, or a combination of the processor and the dedicated circuit. The controller 33 may execute processes related to the operation of the control device 30 while controlling individual parts of the control device 30.

Functions of the control device 30 may be implemented such that the processor corresponding to the controller 33 executes a control program according to this embodiment. That is, the functions of the control device 30 may be implemented by software. The control program may cause a computer to function as the control device 30 by causing the computer to execute the operation of the control device 30. That is, the computer may function as the control device 30 by executing the operation of the control device 30 based on the control program.

The functions of the control device 30 may partially or entirely be implemented by the dedicated circuit corresponding to the controller 33. That is, the functions of the control device 30 may partially or entirely be implemented by hardware.

The controller 33 outputs a signal to the camera 20 to control the operation mode of the camera 20. For example, the controller 33 generally outputs a first signal to the camera 20 to control the operation mode of the camera 20 into a first mode. The first signal is a signal for switching the operation mode of the camera 20 to the first mode.

In the first mode, data on a captured image generated by imaging the room 3 is stored in the camera 20. If the camera device 10 is a surveillance camera, the first mode may be a mode for monitoring the room 3 by imaging the room 3 using the camera 20. When the controller 27 of the camera 20 acquires the first signal from the control device 30, the controller 27 switches the operation mode of the camera 20 to the first mode. In the first mode, the controller 27 of the camera 20 stores, in the storage 26, the data on the captured image generated by imaging the room 3 using the imaging unit 21. The controller 27 may store the data on the captured image in the storage 26 in association with a time when the imaging unit 21 has captured the image. In the first mode, the controller 27 may output the data on the captured image generated by imaging the room 3 using the imaging unit 21 to the control device 30 for a process for detecting a sign of the start of a specific action as described later.

If the camera 20 has the microphone 25, the controller 27 in the first mode may store, in the storage 26, data on sounds in the room 3 that are collected by the microphone 25 together with the data on the captured image generated by imaging the room 3 using the imaging unit 21. If the camera 20 has the shutter 22, the shutter 22 may be open in the first mode. In this case, when the controller 27 acquires the first signal from the control device 30, the controller 27 may output an electric signal for opening the shutter 22 to the driver 23.

Process for Detecting Sign of Start of Specific Action

The controller 33 may detect a sign of the start of a specific action of the user 4. The specific action of the user 4 may be an action that the user 4 or a general person does not want other persons to see.

The specific action of the user 4 may be preset by the user 4. The user 4 may set the specific action of the user 4 by selecting a captured image showing an action that the user 4 does not want other persons to see from among captured images previously generated by the camera 20. The user 4 may select the captured image showing the action that the user 4 does not want other persons to see by viewing the captured images previously generated by the camera 20 using an arbitrary terminal device such as a smartphone. The user 4 may use the terminal device to transmit, to the control device 30, data on the selected captured image and a notification for setting the captured image as the specific action of the user 4. The terminal device and the control device 30 are communicable with each other via the network 100 described later as illustrated in FIG. 4. The controller 33 may receive, from the terminal device via the communicator 31, the data on the captured image and the notification for setting the captured image as the specific action of the user 4. When the controller 33 receives the notification and the like, the controller 33 may store the received data on the captured image in the storage 32 as data on the specific action of the user 4.

The specific action of the user 4 may be set as appropriate based on an action that a general person does not want other persons to see. The specific action of the user 4 may be selected by the user 4 from among a plurality of captured images showing preset actions that general persons do not want other persons to see. Similarly to the above, the user 4 may use the terminal device such as a smartphone to transmit, to the control device 30, data on the selected captured image and a notification for setting the captured image as the specific action of the user 4. Similarly to the above, when the controller 33 receives the notification and the like, the controller 33 may store the received data on the captured image in the storage 32 as data on the specific action of the user 4.

The specific action of the user 4 may include an action that the user 4 takes off clothes. The action that the user 4 takes off clothes may hereinafter be referred to also as “takeoff of clothes by user 4”. For example, the user 4 takes off clothes before taking a bath. After taking off the clothes, the user 4 exits from the room 3 by opening the door 6, and goes to a bathroom.

The specific action of the user 4 may include an action that the user 4 changes clothes. The action that the user 4 changes clothes may hereinafter be referred to also as “change of clothes by user 4”. For example, the user 4 changes clothes when the user 4 wakes up in the morning.

The specific action of the user 4 may include an action that the user 4 touches a valuable item. The action that the user 4 touches a valuable item may hereinafter be referred to also as “touch on valuable item by user 4”. For example, the user 4 touches a bankbook as a valuable item when checking the bankbook.

The controller 33 may detect a sign of the start of the specific action of the user 4 by detecting an action pattern indicating the sign of the start of the specific action of the user 4 from a captured image generated by the camera 20. The action pattern indicating the sign of the start of the specific action of the user 4 may be determined by the controller 33. The controller 33 may determine the action pattern based on a captured image previously generated by the camera 20. For example, the controller 33 determines the action pattern by analyzing the captured image previously generated by the camera 20 and the captured image stored in the storage 32 as the specific action of the user 4.

The controller 33 may detect the sign of the start of the specific action of the user 4 by estimating a start time of the specific action of the user 4. For example, the controller 33 estimates the start time of the specific action of the user 4 by analyzing a captured image previously generated by the camera 20 and the captured image stored in the storage 32 as the specific action of the user 4. The start time of the specific action of the user 4 may be preset by the user 4. The user 4 may use the terminal device such as a smartphone to transmit, to the control device 30, a signal indicating the start time of the specific action of the user 4. When the controller 33 receives the signal from the terminal device via the communicator 31, the controller 33 may store information on the start time of the specific action of the user 4 in the storage 32.

The controller 33 may detect the sign of the start of the specific action of the user 4 based on the action pattern indicating the sign of the start of the specific action of the user 4 and the estimated or set start time of the specific action of the user 4. Examples of the detection of the sign of the start of the specific action of the user 4 are described below.

### EXAMPLE 1

When the specific action of the user 4 is the takeoff of clothes by the user 4, an action pattern indicating a sign of the start of the takeoff of clothes by the user 4 may be an action that the user 4 opens the drawer 7b in the chest of drawers 7. Before taking off the clothes for a bath, the user 4 may open the drawer 7b and pick up a bath towel and underclothes from the drawer 7b. The controller 33 may detect the sign of the start of the takeoff of clothes by the user 4 by detecting the action that the user 4 opens the drawer 7b from a captured image generated by the camera 20 through object recognition employing an algorithm of arbitrary machine learning.

### EXAMPLE 2

When the specific action of the user 4 is the change of clothes by the user 4, an action pattern indicating a sign of the start of the change of clothes by the user 4 may be an action that the user 4 opens the drawer 7c in the chest of drawers 7. For example, when the user 4 wakes up in the morning, the user 4 takes off pajamas and puts on other clothes. Before changing the clothes, the user 4 may open the drawer 7c and pick up clothes to wear from the drawer 7c. The controller 33 may detect the sign of the start of the change of clothes by the user 4 by detecting the action that the user 4 opens the drawer 7c from a captured image generated by the camera 20 through object recognition employing an algorithm of arbitrary machine learning. If the user 4 wakes up at a roughly determined wake-up time, the wake-up time may be preset as the start time of the specific action of the user 4. In this case, the controller 33 may detect the sign of the start of the change of clothes by the user 4 by determining that a current time is around the set start time of the change of clothes by the user 4, and detecting the action that the user 4 opens the drawer 7c from the captured image generated by the camera 20.

### EXAMPLE 3

For example, when the specific action of the user 4 is the touch on a valuable item by the user 4, an action pattern indicating a sign of the start of the touch on the valuable item by the user 4 may be an action that the user 4 opens the drawer 7a in the chest of drawers 7. Before touching the valuable item, the user 4 may open the drawer 7a in the chest of drawers 7 and pick up the valuable item from the drawer 7a. The controller 33 may detect the sign of the start of the touch on the valuable item by the user 4 by detecting the action that the user 4 opens the drawer 7a from a captured image generated by the camera 20 through object recognition employing an algorithm of arbitrary machine learning.

Process for Switching to Second Mode

When the controller 33 detects the sign of the start of the specific action of the user 4, the controller 33 may output a second signal to the camera 20. The second signal is a signal for switching the operation mode of the camera 20 to a second mode. The second mode differs from the first mode. In the second mode, the functions of the first mode may partially be limited. The function of the first mode to be limited in the second mode may be the function of recording an action that the user 4 or a general person does not want other persons to see in the camera 20 in a visible state. When the controller 27 of the camera 20 acquires the second signal from the control device 30, the controller 27 switches the operation mode of the camera 20 to the second mode. In response to the detection of the sign of the start of the specific action of the user 4, the controller 33 may output the second signal to switch the operation mode of the camera 20 to the second mode before the start of the specific action of the user 4. By switching the operation mode of the camera 20 to the second mode before the start of the specific action of the user 4, it is possible to reduce a possibility that the specific action of the user 4 is recorded in the camera 20 as a captured image. That is, the privacy of the user 4 can be protected more securely.

If the camera 20 has the indicator 24, the controller 33 may output, to the camera 20, a signal for keeping the indicator 24 illuminated during the second mode. When the controller 27 of the camera 20 acquires the signal, the controller 27 keeps the indicator 24 illuminated while the operation mode of the camera 20 is the second mode. When the user 4 recognizes the illumination of the indicator 24, the user 4 may know that the operation mode of the camera 20 is the second mode. By knowing that the operation mode of the camera 20 is the second mode, the user 4 can perform the specific action with peace of mind.

During the second mode of the camera 20, the controller 27 may continue to output data on sounds collected by the microphone 25 to the control device 30 for a process for terminating the second mode as described later. There is a case in which the user 4 does not want the camera 20 to record sounds during the specific action of the user 4. In this case, the user 4 may use the terminal device such as a smartphone to transmit, to the control device 30, a signal indicating an instruction for the camera 20 not to record sounds in the second mode. When the controller 33 receives the signal via the communicator 31, the controller 33 may cause the storage 26 not to record sounds collected by the microphone 25 in the second mode. When the signal is not received, the controller 27 may cause the storage 26 to record the sounds collected by the microphone 25.

The second mode may be any one of the following second modes 40, 41, 42, and 43.

### EXAMPLE 1

### Second Mode 40

In the second mode 40, the camera 20 has the shutter 22, and the shutter 22 is closed. In this example, when the controller 27 of the camera 20 acquires the second signal from the control device 30, the controller 27 outputs an electric signal for closing the shutter 22 to the driver 23. When the shutter 22 is closed relative to the lens 21a, the imaging unit 21 cannot image the room 3 as described above. That is, in the second mode 40, a possibility that the camera 20 images the specific action of the user 4 can be reduced by closing the shutter 22 relative to the lens 21a. The user 4 can recognize the closed shutter 22 when the shutter 22 is located, for example, outside the casing of the camera device 10. By recognizing the closed shutter 22, the user 4 may know that the camera 20 cannot image the specific action. By knowing that the camera 20 cannot image the specific action, the user 4 can perform the specific action with peace of mind.

### EXAMPLE 2

### Second Mode 41

In the second mode 41, masking is performed for an image portion corresponding to the user 4 in the captured image generated by the camera 20. In the second mode 41, data on the captured image subjected to the masking is stored in the camera 20. In the masking, an image portion that the user 4 or a general person does not want other persons to see in the captured image is processed as appropriate to reduce the visibility of the image portion. Examples of the masking include pixelation, a process for superimposing a masking image, and a process for reducing the resolution of an image. For example, the controller 33 determines an image portion corresponding to the user 4 from a captured image generated by the camera 20 through object recognition employing an algorithm of arbitrary machine learning. The controller 33 performs arbitrary masking for the determined image portion. The controller 33 outputs data on the captured image subjected to the masking to the camera 20. The controller 33 may temporarily store data on a pre-masked captured image in the storage 32 for a process for detecting the end of the specific action as described later.

When the controller 27 of the camera 20 acquires the second signal from the control device 30, the controller 27 stores the data on the captured image subjected to the masking by the control device 30 in the storage 26 instead of the data on the captured image generated through the imaging performed by the imaging unit 21.

In the second mode 41, the controller 27 of the camera 20 may perform the masking in place of the controller 33 of the control device 30. In this case, when the controller 27 acquires the second signal from the control device 30, the controller 27 may perform the masking for the data on the captured image generated through the imaging performed by the imaging unit 21. The controller 27 may store the data on the captured image subjected to the masking in the storage 26. The controller 27 may continue to output the data on the pre-masked captured image to the control device 30 for the process for detecting the end of the specific action as described later.

### EXAMPLE 3

### Second Mode 42

In the second mode 42, the masking is performed for the image portion corresponding to the user 4 in the captured image generated by the camera 20 when determination is made that the user 4 is a resident of the house 2. In the second mode 42, data on the captured image subjected to the masking is stored in the camera 20. In this example, the controller 33 may determine whether the user 4 is the resident of the house 2 by applying facial recognition employing an algorithm of arbitrary machine learning to the captured image generated by the camera 20. As an example of the application of the facial recognition, the controller 33 determines a facial image of the user 4 from the captured image generated by the camera 20. The controller 33 determines whether the user 4 is the resident of the house 2 by comparing data on the determined facial image of the user 4 and data on a facial image of the resident of the house 2 that is stored in the storage 32. When the controller 33 determines that the user 4 is the resident of the house 2, the controller 33 may perform the masking for the image portion corresponding to the user 4 and output data on the captured image subjected to the masking to the camera 20 similarly to the process in the second mode 41. The controller 33 may temporarily store data on a pre-masked captured image in the storage 32 for the process for detecting the end of the specific action as described later.

When the controller 27 of the camera 20 acquires the second signal from the control device 30, the controller 27 stores the data on the captured image subjected to the masking by the control device 30 in the storage 26 instead of the data on the captured image generated through the imaging performed by the imaging unit 21.

In the second mode 42, the masking need not be performed for an image portion corresponding to a person who is not the resident of the house 2 in the captured image generated by the camera 20. That is, the controller 33 need not perform the masking for the image portion corresponding to the person who is not the resident of the house 2 in the captured image generated by the camera 20. For example, when the controller 33 determines that the user 4 is not the resident of the house 2, the controller 33 does not perform the masking for the image portion corresponding to the user 4. With this configuration, the person who is not the resident of the house 2, such as a suspicious person, can be recorded in the camera 20 as the captured image.

In the second mode 42, in place of the controller 33 of the control device 30, the controller 27 of the camera 20 may determine that the user 4 is the resident of the house 2, and perform the masking for the image portion corresponding to the user 4 in the captured image generated by the imaging unit 21. In this case, when the controller 27 acquires the second signal from the control device 30, the controller 27 may perform the facial recognition and the masking for the data on the captured image generated through the imaging performed by the imaging unit 21. The controller 27 may store the data on the captured image subjected to the masking in the storage 26. Similarly to the above, the controller 27 need not perform the masking for the image portion corresponding to the person who is not the resident of the house 2 in the captured image generated by the camera 20. The controller 27 may continue to output the data on the pre-masked captured image to the control device 30 for the process for detecting the end of the specific action as described later.

### EXAMPLE 4

### Second Mode 43

In the second mode 43, the data on the captured image generated by the camera 20 is not stored in the camera 20. In this example, when the controller 27 of the camera 20 acquires the second signal from the control device 30, the controller 27 does not store the data on the captured image generated by the imaging unit 21 in the storage 26. During the second mode 43, the controller 27 may continue to output the data on the captured image generated by the imaging unit 21 to the control device 30 for the process for detecting the end of the specific action as described later. The controller 33 may temporarily store the data on the captured image acquired from the camera 20 in the storage 32 for the process for detecting the end of the specific action as described later.

Process for Detecting End of Specific Action

When the operation mode of the camera 20 is the second mode after the second signal is output, the controller 33 may detect the end of the specific action of the user 4. The controller 33 may detect the end of the specific action of the user 4 by detecting an action pattern indicating the end of the specific action of the user 4. The controller 33 may detect the action pattern indicating the end of the specific action of the user 4 based on a captured image generated by the camera 20 and at least one of the other elements such as the motion sensor 5. When the camera 20 is in any one of the second modes 41 to 43, the controller 33 may acquire captured images generated by the camera 20 also while the camera 20 is in the second mode as described above. The action pattern indicating the end of the specific action of the user 4 may be determined by the controller 33. For example, the controller 33 determines the action pattern by analyzing the captured image previously generated by the camera 20 and the captured image stored in the storage 32 as the specific action of the user 4.

The controller 33 may detect the end of the specific action of the user 4 by estimating an end time of the specific action of the user 4. For example, the end time of the specific action of the user 4 is estimated by analyzing a captured image previously generated by the camera 20 and the captured image stored in the storage 32 as the specific action of the user 4. Similarly to the process for detecting the sign of the start of the specific action of the user 4, the end time of the specific action of the user 4 may be preset by the user 4.

The controller 33 may detect the end of the specific action of the user 4 based on the action pattern indicating the end of the specific action of the user 4 and the estimated or set end time of the specific action of the user 4. Examples of the detection of the end of the specific action of the user 4 are described below.

### EXAMPLE 1

When the specific action of the user 4 is the takeoff of clothes by the user 4, the action pattern indicating the end of the specific action of the user 4 may be an action that the user 4 exits from the room 3. For example, after taking off the clothes, the user 4 exits from the room 3 by opening the door 6, and goes to the bathroom as described above.

That is, the user 4 may be out of the room 3 after taking off the clothes. The controller 33 may detect the end of the specific action of the user 4, that is, the takeoff of clothes by the user 4 by detecting that no person is present in the room 3 using the motion sensor 5. The controller 33 may receive detection information indicating the presence or absence of a person in the room 3 from the motion sensor 5 via the communicator 31. The controller 33 may detect that no person is present in the room 3 by receiving the detection information from the motion sensor 5.

The controller 33 may detect the action that the user 4 exits from the room 3 as the action pattern indicating the end of the specific action of the user 4 from an image captured by the camera 20 in any one of the second modes 41 to 43. The controller 33 may detect the action that the user 4 exits from the room 3 from the captured image generated by the camera 20 through object recognition employing an algorithm of arbitrary machine learning.

### EXAMPLE 2

When the specific action of the user 4 is the change of clothes by the user 4, the action pattern indicating the end of the specific action of the user 4 may be a difference in the clothes that the user 4 is wearing. For example, when the user 4 wakes up in the morning, the user 4 takes off pajamas and puts on other clothes as described above. That is, the clothes that the user 4 is wearing may be different after the user 4 has changed the clothes. The controller 33 may detect the difference in the clothes that the user 4 is wearing from a captured image generated by the camera 20 in any one of the second modes 41 to 43 through object recognition employing an algorithm of arbitrary machine learning.

### EXAMPLE 3

When the specific action of the user 4 is the touch on a valuable item by the user 4, the action pattern indicating the end of the specific action of the user 4 may be an action that the user 4 opens the drawer 7a in the chest of drawers 7 again. After the user 4 has touched the valuable item, the user 4 may store the valuable item in the drawer 7a again. That is, the drawer 7a may be opened again after the user 4 has touched the valuable item. The controller 33 may detect the action that the user 4 opens the drawer 7a again from a captured image generated by the camera 20 in any one of the second modes 41 to 43 through object recognition employing an algorithm of arbitrary machine learning.

Process for Switching to First Mode

When the end of the specific action of the user 4 is detected, the controller 33 may output, to the camera 20, the first signal for switching the operation mode of the camera 20 to the first mode. When the controller 27 of the camera 20 acquires the first signal from the control device 30, the controller 27 switches the operation mode of the camera 20 to the first mode. In response to the detection of the end of the specific action of the user 4, the controller 33 may output the first signal to switch the operation mode of the camera 20 to the first mode after the end of the specific action of the user 4. By switching the operation mode of the camera 20 to the first mode after the end of the specific action of the user 4, it is possible to reduce the possibility that the specific action of the user 4 is recorded in the camera 20 as a captured image. The operation mode of the camera 20 can be returned to the first mode while protecting the privacy of the user 4 more securely.

Process for Terminating Second Mode

When the camera 20 is in the second mode after the second signal is output, the controller 33 may output a third signal to the camera 20 depending on a situation. The third signal is a signal for terminating the second mode of the camera 20 and switching the operation mode of the camera 20 to the first mode.

### EXAMPLE 1

While the camera 20 is in the second mode, the controller 33 may acquire data on sounds collected by the microphone 25 from the camera 20. When the microphone 25 detects a sound having a frequency higher than a frequency threshold, the controller 33 may output the third signal to the camera 20. The frequency threshold may be set based on a frequency of a scream of the user 4 or based on frequencies of screams of all residents including the user 4 in the house 2. For example, the frequency threshold is the lowest frequency among the frequencies of the screams of all the residents including the user 4 in the house 2. For example, the resident may scream when the resident fears for his/her safety due to a suspicious person appearing in the room 3. With this configuration, when the user 4 screams in the fear for his/her safety, the second mode of the camera 20 may be terminated and the operation mode of the camera 20 may be switched to the first mode. For example, even when the operation mode of the camera 20 is the second mode 40 or 43 in which the captured image of the room 3 is not stored, a suspicious person or the like may be recorded in the camera 20 as the captured image by switching the operation mode of the camera 20 to the first mode.

### EXAMPLE 2

While the camera 20 is in the second mode, the controller 33 may acquire data on sounds collected by the microphone 25 from the camera 20. When the microphone 25 detects a sound having a sound pressure higher than a sound pressure threshold, the controller 33 may output the third signal to the camera 20. The sound pressure threshold may be set based on a sound pressure of the scream of the user 4 or based on sound pressures of the screams of all the residents including the user 4 in the house 2. For example, the sound pressure threshold is the lowest sound pressure among the sound pressures of the screams of all the residents including the user 4 in the house 2. With this configuration, an effect similar to that in Example 1 is attained.

Operations of Control System

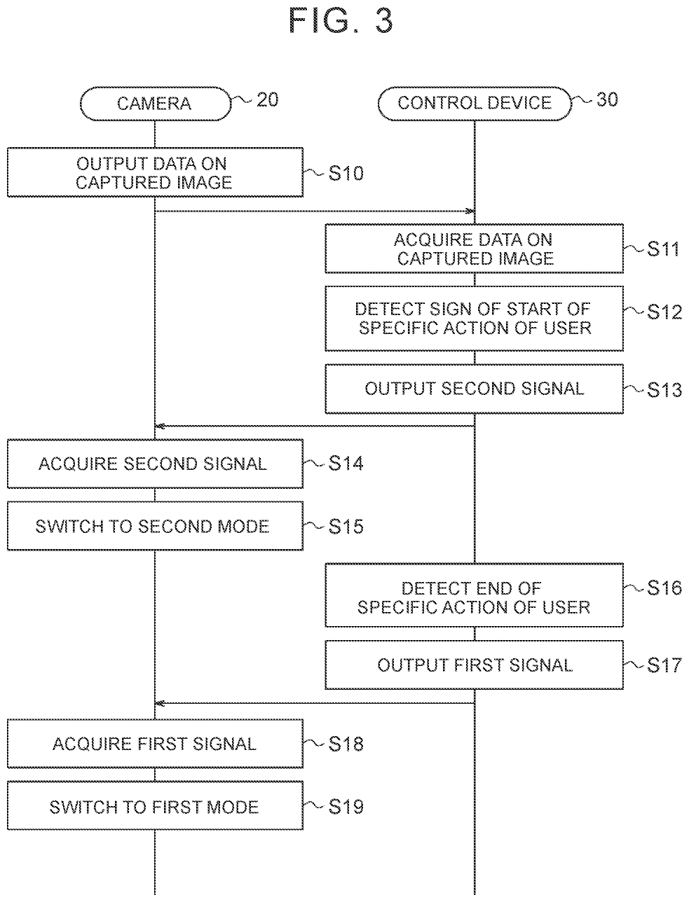

An example of operations of the control system 1 illustrated in FIG. 1 is described with reference to FIG. 3. The operations correspond to an example of a control method according to this embodiment. Prior to executing a process of Step S10, the operation mode of the camera 20 is the first mode.

While the camera 20 is in the first mode, the controller 27 outputs data on an image captured by the camera 20 to the control device 30 (Step S10).

In the control device 30, the controller 33 acquires the data on the captured image from the camera 20 (Step S11). The controller 33 detects a sign of the start of the specific action of the user 4 by detecting the action pattern indicating the sign of the start of the specific action of the user 4 from the captured image generated by the camera 20 (Step S12). When the sign of the start of the specific action of the user 4 is detected, the controller 33 outputs the second signal to the camera 20 (Step S13).

When the controller 27 of the camera 20 acquires the second signal from the control device 30 (Step S14), the controller 27 switches the operation mode of the camera 20 to the second mode (Step S15).

In the control device 30, the controller 33 detects the end of the specific action of the user 4 by detecting the action pattern indicating the end of the specific action of the user 4 (Step S16). When the end of the specific action of the user 4 is detected, the controller 33 outputs the first signal to the camera 20 (Step S17).

When the controller 27 of the camera 20 acquires the first signal from the control device 30 (Step S18), the controller 27 switches the operation mode of the camera 20 to the first mode (Step S19).

In the control system 1, when the sign of the start of the specific action of the user 4 is detected, the control device 30 outputs, to the camera 20, the second signal for switching the operation mode of the camera 20 to the second mode. When the controller 27 of the camera 20 acquires the second signal from the control device 30, the controller 27 switches the operation mode of the camera 20 to the second mode. With this configuration, the operation mode of the camera 20 can be switched to the second mode before the start of the specific action of the user 4. By switching the operation mode of the camera 20 to the second mode before the start of the specific action of the user 4, it is possible to reduce the possibility that the specific action of the user 4 is recorded in the camera 20 as a captured image. According to this embodiment, the privacy of the user 4 can be protected more securely.

In the control system 1, the operation mode of the camera 20 may automatically be switched before the start of the specific action of the user 4 even though the user 4 does not switch the operation mode of the camera 20 to the second mode. With this configuration, the control system 1 can excel in convenience of the user 4.

The present disclosure is not limited to the embodiment described above. For example, the plurality of blocks illustrated in the block diagram may be integrated, or one block may be divided. Instead of executing the plurality of steps illustrated in the flowchart in time series as described, the steps may be executed in parallel or in different order as necessary or depending on throughput of the device that executes the individual steps. Further modifications may be made without departing from the spirit of the present disclosure.

For example, in the embodiment described above, the indoor place to be imaged by the camera device 10 is the room 3 in the house 2. The indoor place to be imaged by the camera device 10 is not limited to the room 3 in the house 2. The indoor place to be imaged by the camera device 10 may be an indoor place in an arbitrary building. For example, the indoor place to be imaged by the camera device 10 is a locker room in a sports facility. In this case, the specific action of the user may be change of clothes. The action pattern indicating the sign of the start of the specific action of the user may be an action of opening a door of a locker in the locker room. The user may open the door of the locker before changing clothes. The action pattern indicating the end of the specific action of the user may be a difference in the clothes that the user is wearing. For example, if the sports facility is a swimming pool, the user may change clothes from ordinary clothes to swimwear or from swimwear to ordinary clothes.

For example, in the embodiment described above, when the specific action of the user 4 is the takeoff of clothes by the user 4, the action pattern indicating the end of the specific action of the user 4 is the action that the user 4 exits from the room 3. The setting of the action pattern indicating the end of the specific action of the user 4 to the action that the user 4 exits from the room 3 may be applied to an arbitrary specific action of the user 4.

For example, in the embodiment described above, one camera device 10 includes the camera 20 and the control device 30 as illustrated in FIG. 2. The camera 20 and the control device 30 may be separate devices as illustrated in FIG. 4.

As illustrated in FIG. 4, a control system 101 according to another embodiment of the present disclosure includes a camera 120 and an information processing device 130. The camera 120 and the information processing device 130 are communicable with each other via the network 100. The network 100 may be an arbitrary network including a mobile communication network and the Internet.

As illustrated in FIG. 4, the camera 120 may further include a communicator 28. The communicator 28 may include at least one communication module connectable to the network 100. For example, the communication module conforms to standards such as a wired LAN or a wireless LAN. The communicator 28 may be connected to the network 100 via the wired LAN or the wireless LAN by using the communication module. The controller 27 may cause the communicator 28 to receive an arbitrary signal from the information processing device 130 via the network 100. For example, the controller 27 receives the first signal, the second signal, and the third signal from the information processing device 130. When those signals are received, the controller 27 switches an operation mode of the camera 120 similarly to the embodiment described above.

The information processing device 130 illustrated in FIG. 4 may be a dedicated computer, a general-purpose personal computer, or a cloud computing system configured to function as a server. The information processing device 130 includes the control device 30. Using a communication module conforming to standards such as a wired LAN or a wireless LAN, the communicator 31 may be connected to the network 100 via the wired LAN or the wireless LAN. The controller 33 may cause the communicator 31 to transmit an arbitrary signal to the camera 120 via the network 100. For example, the controller 33 transmits the first signal, the second signal, and the third signal to the camera 120 by executing processes similar to those in the embodiment described above. The controller 33 may cause the communicator 31 to receive the detection information indicating the presence or absence of a person in the room 3 from the motion sensor 5 via the network 100.

What is claimed is:

1. A control device comprising a controller configured to output, when a sign of starting a specific action by a user is detected, a signal for switching an operation mode of a camera from a first mode to a second mode different from the first mode, the camera being configured to operate in the first mode in which data on a captured image generated by imaging an indoor place is stored in the camera.

2. The control device according to claim 1, wherein the controller is configured to output a signal for switching the operation mode of the camera to the first mode when an end of the specific action is detected.

3. The control device according to claim 2, wherein the controller is configured to detect the end of the specific action by detecting an action pattern indicating the end of the specific action from the captured image generated by the camera.

4. The control device according to claim 1, wherein
when the operation mode of the camera is the second mode, masking is performed for an image portion corresponding to the user in the captured image generated by the camera and data on the captured image subjected to the masking is stored in the camera.

5. The control device according to claim 1, wherein:
the indoor place is a room in a house; and
when the operation mode of the camera is the second mode, masking is performed for an image portion corresponding to the user in the captured image generated by the camera based on determination that the user is a resident of the house and data on the captured image subjected to the masking is stored in the camera.

6. The control device according to claim 5, wherein
when the operation mode of the camera is the second mode, the masking is not performed for an image portion corresponding to a person who is not the resident of the house in the captured image generated by the camera.

7. The control device according to claim 1, wherein
when the operation mode of the camera is the second mode, the data on the captured image generated by the camera is not stored in the camera.

8. The control device according to claim 1, wherein the controller is configured to output, after the signal for switching the operation mode of the camera to the second mode is output, a signal for switching the operation mode of the camera to the first mode based on detecting an end of the specific action by detecting that no person is present in the indoor place by using a motion sensor.

9. The control device according to claim 4, wherein the controller is configured to output, after the signal for switching the operation mode of the camera to the second mode is output, a signal for switching the operation mode of the camera to the first mode based on detecting an end of the specific action by detecting that the user exits from the indoor place from the captured image generated by the camera.

10. The control device according to claim 8, wherein the specific action of the user is an action that the user takes off clothes.

11. The control device according to claim 1, wherein the specific action is an action that the user changes clothes.

12. The control device according to claim 1, wherein the controller is configured to detect the sign of starting the specific action by detecting an action pattern indicating the sign of starting the specific action from the captured image generated by the camera.

13. The control device according to claim 12, wherein the controller is configured to determine the action pattern indicating the sign of starting the specific action based on a captured image previously generated by the camera.

14. The control device according to claim 1, wherein the specific action is preset by the user.

15. A non-transitory storage medium storing instructions that are executable by one or more processors in a computer and that cause the one or more processors to perform functions comprising:
causing a camera to operate in a first mode in which data on a captured image generated by imaging an indoor place is stored in the camera; and
outputting, when a sign of starting a specific action by a user is detected, a signal for switching an operation mode of the camera to a second mode different from the first mode.

16. A control system comprising:
a camera configured to operate in a first mode in which data on a captured image generated by imaging an indoor place is stored in the camera; and
a control device configured to output, when a sign of starting a specific action by a user is detected, a signal for switching an operation mode of the camera to a second mode different from the first mode.

17. The control system according to claim 16, wherein:
the camera includes a shutter configured to be openable and closable relative to a lens of the camera;
the shutter is configured to be open relative to the lens in the first mode; and
the shutter is configured to be closed relative to the lens in the second mode.

18. The control system according to claim 16, wherein:
the camera includes an indicator; and
a controller of the control device is configured to output a signal for keeping the indicator illuminated while the operation mode of the camera is the second mode.

19. The control system according to claim 16, wherein:
the camera includes a microphone configured to collect sounds in the indoor place; and
a controller of the control device is configured to output, after the signal for switching the operation mode of the camera to the second mode is output, a signal for terminating the second mode and switching the operation mode of the camera to the first mode based on detecting a sound having a frequency higher than a frequency threshold by the microphone.

20. The control system according to claim 16, wherein:
the camera includes a microphone configured to collect sounds in the indoor place; and
a controller of the control device is configured to output, after the signal for switching the operation mode of the camera to the second mode is output, a signal for terminating the second mode and switching the operation mode of the camera to the first mode based on detecting a sound having a sound pressure higher than a sound pressure threshold by the microphone.
